(19) United States
(12) Patent Application Publication
(10) Pub. No.: US 2026/0197274 A1
(43) Pub. Date: Jul. 9, 2026

(54) Data Processing Method, Smart Network Interface Card, and Electronic Device

(71) Applicant: CLOUD INTELLIGENCE ASSETS HOLDING (SINGAPORE) PRIVATE LIMITED, Singapore (SG)

(72) Inventors: Yilong LYU, Hangzhou, Zhejiang (CN); Zikang CHEN, Hangzhou, Zhejiang (CN)

(21) Appl. No.: 19/133,442

(22) PCT Filed: Nov. 29, 2023
(86) PCT No.: PCT/CN2023/135223

§ 371 Date: May 28, 2025

(30) Foreign Application Priority Data
Nov. 29, 2022 (CN) 202211513275.6

(51) Int. Cl. H04L 45/74

(52) U.S. Cl. CPC H04L 45/742

(57) ABSTRACT

The present disclosure relates to a smart network interface card, a data processing method, and an electronic device. The smart network interface card includes: a hardware layer and a software layer; the hardware layer includes a packet parsing module, a first storage module, a first flow table lookup module, and a first transmission module; the packet parsing module parses a packet; a first forwarding flow table in the first storage module includes flow identification information and packet matching domain information corresponding to the flow identification information; the first flow table lookup module looks up the packet matching domain information matching packet information and the flow identification information corresponding to the packet matching domain information; the first transmission module sends the flow identification information and the packet information to a fastpath module of the software layer; the fastpath module processes the packet information according to execution action information.

The present disclosure claims priority of Chinese Patent Application No. 202211513275.6, filed to China National Intellectual Property Administration on Nov. 29, 2022 and titled “Data Processing Method, Smart Network Interface Card, and Electronic Device”, the content of which is hereby incorporated by reference in its entirety.

### TECHNICAL FIELD

The present disclosure relates to the field of computer technology, and in particular, to a smart network interface card and a data processing method, and further in particular, to a computer storage medium and an electronic device.

### BACKGROUND OF THE INVENTION

Traditional data centers are based on a von Neumann architecture, where all data are sent to a Central Processing Unit (CPU) for processing. With the rapid development of data centers and the slowing down and eventual failure of Moore's Law, the marginal cost of increasing general-purpose CPU performance has risen sharply, and the processing speed of the CPU no longer meets the requirements for data processing. To address the evolution of network bandwidth from mainstream 10 G towards 25 G, 40 G, 100 G, 200 G, and even 400 G, the computing architecture has shifted from a CPU-centric Onload mode to a data-centric Offload mode. The task for reducing the burden on the CPU falls on a network interface card (namely network adapter), which is also one of factors driving the rapid development of the network interface card. As technology continues to advance, the network interface card has evolved from a basic functionality network interface card to a smart network interface card (first-generation smart network interface card), and further to a Data Processing Unit (DPU) smart network interface card (second-generation smart network interface card, where the DPU is a data-centric specialized processor).

Whether it is the first-generation smart network interface card or the second-generation DPU smart network interface card, both not only provide the Ethernet connectivity of a traditional basic network interface card, but also offload a packet processing task from the CPU, thereby unloading network processing workload and related tasks, such as virtual switching, security isolation, Quality of Service (QoS), and other network operation management tasks, as well as some High Performance Computing (HPC) and Artificial Intelligence (AI) machine learning tasks, of the CPU, thereby allowing CPU cores to be freed up and CPU resources to be saved for handling application business tasks.

Therefore, the smart network interface card can reduce CPU load and enhance overall data performance on one hand, and increase the processing speed of CPU for application tasks on the other hand.

### SUMMARY OF THE INVENTION

At least some embodiments of the present disclosure provide a data processing method, so as to solve a problem of low data forwarding performance and inflexible data forwarding in the related art.

Some embodiments of the present disclosure provide a smart network interface card including a hardware layer and a software layer;
the hardware layer includes a packet parsing module, a first storage module, a first flow table lookup module, and a first transmission module; where the packet parsing module is arranged for parsing a packet to obtain packet information; the first storage module is arranged for storing a first forwarding flow table, the first forwarding flow table includes flow identification information and packet matching domain information corresponding to the flow identification information, but does not include execution action information corresponding to the packet matching domain information; the first flow table lookup module is arranged for looking up the packet matching domain information matching the packet information and the flow identification information corresponding to the packet matching domain information from the first forwarding flow table; the first transmission module is arranged for sending the flow identification information found by the first flow table lookup module and the packet information to a fastpath module in the software layer; and
the software layer includes the fastpath module; the fastpath module includes a second storage module, a second flow table lookup module and a processing module; the second storage module is arranged for storing a second forwarding flow table, the second forwarding flow table includes flow identification information, packet matching domain information corresponding to the flow identification information, and execution action information corresponding to the packet matching domain information; the second flow table lookup module is arranged for looking up target flow identification information matching the flow identification information sent by the first transmission module from the second forwarding flow table; the processing module is arranged for processing the packet information based on the execution action information corresponding to the target flow identification information.

In some embodiments, the software layer further includes a slowpath module; the slowpath module includes a generation module and a third transmission module; the generation module is arranged for generating, in response to the first forwarding flow table not containing the packet matching domain information matching the packet information, and/or in response to the packet is an initial packet, a third forwarding flow entry according to the processing performed on at least one of the packet information and the initial packet, the third forwarding flow entry includes the packet matching domain information corresponding to at least one of the packet information and the initial packet, the flow identification information corresponding to the packet matching domain information, and the execution action information corresponding to the packet matching domain information; the third transmission module is arranged for sending the flow identification information and the packet matching domain information in the third forwarding flow entry to the first storage module of the hardware layer, and sending the third forwarding flow entry to the second storage module of the fastpath module.

In some embodiments, the hardware layer further includes a data cache, the data cache includes multiple data cache queues, arranged for caching the packet information that has completed the lookup in the first forwarding flow table in pre-set batches, and caching the packet information with the same flow identification information in the same data cache queue;
the first transmission module in the hardware layer is arranged for simultaneously sending the packet information and the flow identification information of the same group of packets stored in the same data cache queue to the fastpath module in the software layer; and
the processing module in the fastpath module is arranged for looking up target flow identification information from the second forwarding flow table and performing the same processing on the packet information in the same data cache queue based on target execution action information corresponding to the target flow identification information.

Some embodiments of the present disclosure further provide a data processing method, the data processing method is applied to the smart network interface card, and the method includes that:
a hardware layer receives a packet to be processed, parses the packet to be processed to obtain packet information, and looks up whether or not packet matching domain information matching the packet information is contained in the first forwarding flow table;
in response to looking up the packet matching domain information matching the packet information from the first forwarding flow table, flow identification information corresponding to the packet matching domain information and the packet information are sent to a software layer;
a fastpath module in the software layer looks up target flow identification information matching the flow identification information from a second forwarding flow table based on the flow identification information, determines target execution action information corresponding to the packet information based on the target flow identification information; and the fastpath module processes the packet information based on the target execution action information.

In some embodiments, the method further includes that:
in response to a finding result of the first forwarding flow table indicating that the first forwarding flow table does not contain the packet matching domain information matching the packet information, and/or, in response to the packet to be processed being an initial packet, the hardware layer sends at least one of the packet information and the initial packet to a slowpath module in the software layer;
the slowpath module generates a third forwarding flow entry based on the processing performed on at least one of the packet information and the initial packet, the third forwarding flow entry includes the packet matching domain information corresponding to at least one of the packet information and the initial packet, the flow identification information corresponding to the packet matching domain information, and execution action information corresponding to the packet matching domain information, sending the third forwarding flow entry to a second storage module of the fastpath module, and sending the flow identification information and the packet matching domain information in the third forwarding flow entry to a first storage module of the hardware layer;
the second storage module of the fastpath module updates the second forwarding flow table based on the third forwarding flow entry and processes the packet information based on the execution action information corresponding to the packet information recorded in the updated second forwarding flow table; and
the first storage module of the hardware layer updates the first forwarding flow table based on the flow identification information and the packet matching domain information in the third forwarding flow entry.

In some embodiments, the method further includes that:
the hardware layer divides the packet information that has completed the lookup in the first forwarding flow table in pre-set batches into the same group of packets according to the same flow identification information, and caches the packet information of the same group of packets in a data cache queue of the hardware layer, where the packet information with the same flow identification information is cached in the same data cache queue;
the flow identification information and the packet information of the same group of packets are simultaneously sent to the fastpath module; and
the fastpath module looks up the target flow identification information matching the flow identification information from the second forwarding flow table based on the flow identification information, and processes the packet information of the same group of packets based on the target execution action information, determined according to the target flow identification information, corresponding to the packet information of the same group of packets.

In some embodiments, an operation of sending the flow identification information and the packet information of the same group of packets to the fastpath module includes that:
the flow identification information of the same group of packets is sent to the fastpath module in vector form, where a vector includes the same flow identification information of the same group of packets; and
the fastpath module looking up the target flow identification information matching the flow identification information from the second forwarding flow table based on the flow identification information, and processing the packet information of the same group of packets based on the target execution action information, determined according to the target flow identification information, corresponding to the packet information of the same group of packets includes that:
the fastpath module looks up the target flow identification information matching the same flow identification information from the second forwarding flow table based on the same flow identification information, and processes the packet information of the same group of packets based on the target execution action information corresponding to the target flow identification information.

Some embodiments of the present disclosure further provide a smart network interface card, including: a hardware layer and a software layer;
the hardware layer includes a packet parsing module, a first storage module, a first flow table lookup module, a first transmission module, and a first processing module; where the packet parsing module is arranged for parsing a packet to obtain packet information; the first storage module is arranged for storing a first forwarding flow table, the first forwarding flow table includes flow identification information, packet matching domain information corresponding to the flow identification information, and execution action information corresponding to the packet matching domain information; the first flow table lookup module is arranged for looking up the packet matching domain information matching the packet information, and the flow identification information corresponding to the packet matching domain information from the first forwarding flow table; the first processing module is arranged for processing the packet information based on the execution action information in response to the first forwarding flow table including the execution action information corresponding to the flow identification information; the first transmission module is arranged for sending the flow identification information and the packet information to a fastpath module in the software layer in response to the first forwarding flow table not containing the execution action information corresponding to the flow identification information; and
the software layer includes the fastpath module, the fastpath module includes a second storage module, a second flow table lookup module, and a second processing module; the second storage module is arranged for storing a second forwarding flow table, the second forwarding flow table includes the flow identification information, the packet matching domain information corresponding to the flow identification information, and the execution action information corresponding to the packet matching domain information; the second flow table lookup module is arranged for looking up the target flow identification information matching the flow identification information sent by the first transmission module from the second forwarding flow table; the second processing module is arranged for processing the packet information based on the target execution action information corresponding to the target flow identification information.

In some embodiments, the first transmission module is further arranged for sending the packet information to a slowpath module in the software layer in response to the first forwarding flow table not containing the packet matching domain information corresponding to the packet information;
the slowpath module in the software layer includes a generation module and a third transmission module, the generation module is arranged for generating a third forwarding flow entry based on the processing performed on the packet information in response to the first forwarding flow table not containing the packet matching domain information matching the packet information, and/or in response to the packet being an initial packet, the third forwarding flow entry includes the packet matching domain information corresponding to at least one of the packet information and the initial packet, the flow identification information corresponding to the packet matching domain information, and the execution action information corresponding to the packet matching domain information; the third transmission module is arranged for sending the third forwarding flow entry to the second storage module, in response to the hardware layer not supporting the processing of the execution action information, sending the flow identification information and the packet matching domain information in the third forwarding flow entry to the first storage module, and in response to the hardware layer supporting the processing of the execution action information, sending the third forwarding flow entry to the first storage module.

In some embodiments, the hardware layer further includes a data cache, the data cache includes multiple data cache queues, arranged for caching the packet information that has completed the lookup in the first forwarding flow table in pre-set batches, and caching the packet information with the same flow identification information in the same data cache queue;
the first transmission module in the hardware layer is arranged for simultaneously sending the packet information and the flow identification information of the same group of packets stored in the same data cache queue to the fastpath module in the software layer; and
the processing module in the fastpath module is arranged for looking up target flow identification information from the second forwarding flow table and performing the same processing on the packet information in the same data cache queue based on target execution action information corresponding to the target flow identification information.

Some embodiments of the present disclosure further provide a data processing method, applied to a smart network interface card, and the method includes that:
a hardware layer receives a packet to be processed, parses the packet to be processed to obtain packet information, and looks up whether or not packet matching domain information matching the packet information and flow identification information are contained in the first forwarding flow table;
in response to the first forwarding flow table containing the packet matching domain information matching the packet information and the flow identification information, it is determined whether or not execution action information corresponding to the packet matching domain information is contained in the first forwarding flow table;
in response to the first forwarding flow table not containing the execution action information corresponding to the packet matching domain information, the packet information and the flow identification information are sent to a fastpath module in the software layer;
the fastpath module looks up target flow identification information matching the flow identification information from the second forwarding flow table based on the flow identification information;
the fastpath module processes the packet information based on the target execution action information corresponding to the target flow identification information; and
in response to the first forwarding flow table containing the execution action information corresponding to the packet matching domain information, the hardware layer processes the packet information based on the execution action information corresponding to the packet matching domain information.

In some embodiments, the method further includes that: in response to the first forwarding flow table not containing the packet matching domain information corresponding to the packet information, and/or in response to the packet to be processed being an initial packet, at least one of the packet information and the initial packet is sent to a slowpath module in the software layer;
the slowpath module generates a third forwarding flow entry based on the processing performed on at least one of the packet information and the initial packet, the third forwarding flow entry includes the flow identification information corresponding to at least one of the packet information and the initial packet, the packet matching domain information corresponding to the flow identification information, and the execution action information corresponding to the packet matching domain information; and
the third forwarding flow entry is sent to the second storage module, in response to the hardware layer not supporting the processing of the execution action information, the flow identification information corresponding to the packet information and the packet matching domain information corresponding to the flow identification information from the third forwarding flow entry are sent to the first storage module, and in response to the hardware layer supporting the processing of the execution action information, the third forwarding flow entry is sent to the first storage module.

Some embodiments of the present disclosure further provide a data processing method, applied to a hardware network interface card, the hardware network interface card stores a first forwarding flow table, the first forwarding flow table includes flow identification information and packet matching domain information corresponding to the flow identification information, but the first forwarding flow table does not include execution action information corresponding to the packet matching domain information, where the method includes that:
a packet to be processed is obtained and the packet is parsed to obtain packet information;
based on the packet information, whether or not flow identification information matching the packet information and packet matching domain information matching the packet information are contained in the first forwarding flow table;
in response to the first forwarding flow table containing the flow identification information matching the packet information and the packet matching domain information matching the packet information, the packet information and the flow identification information are sent; and
in response to the first forwarding flow table not containing the flow identification information matching the packet information and the packet matching domain information matching the packet information, the packet information is sent.

Some embodiments of the present disclosure further provide a data processing method, applied to a software network interface card, the software network interface card stores a second forwarding flow table, the second forwarding flow table includes flow identification information, packet matching domain information corresponding to the flow identification information, and execution action information corresponding to the packet matching domain information, where the method includes that:
flow identification information and parsed packet information sent by a hardware network interface card are received;
the second forwarding flow table is found to determine whether or not target flow identification information matching the flow identification information sent by the hardware network interface card is contained in the second forwarding flow table; and
in response to the second forwarding flow table containing the target flow identification information matching the flow identification information, the packet information is processed based on target execution action information corresponding to the target flow identification information.

Some embodiments of the present disclosure further provide an electronic device, including:
a processor; and
a smart network interface card, arranged for receiving an execution task from the processor and processing the execution task according to the data processing method mentioned above.

Some embodiments of the present disclosure further provide a computer storage medium, arranged for storing data generated by a network platform and a program for processing the data generated by the network platform;
when reading and executing by a processor, the program performs the data processing method mentioned above.

Compared with the related art, the present disclosure has the following advantages.

The smart network interface card provided by the present disclosure, through the first forwarding flow table in the hardware layer storing the flow identification information and the packet matching domain information corresponding to the flow identification information, without storing the execution action information corresponding to the packet matching domain information, therefore, during a packet processing process, the hardware layer is responsible for parsing and looking up, and the fastpath module in the software layer looks up the target flow identification information matching the received flow identification information in the second forwarding flow table, determines the target execution action information according to the target flow identification information, and processes the received packet information according to the target execution action information, thereby allowing the more time-consuming actions of packet parsing and flow identification information lookup to be handled at the hardware layer, while the more frequently changing execution action information is processed by the software layer, to ensure effectiveness and improve processing performance, as well as to ensure flexibility.

The data processing method provided by the present disclosure uses the flow identification information to distinguish the packet information, at the same time, storing the packet matching domain information and the flow identification information in the first forwarding flow table of the hardware layer; and storing the flow identification information, the packet matching domain information, and the execution action information in the second forwarding flow table of the fastpath module in the software layer. When the hardware layer has the packet matching domain information matching the packet information, the flow identification information corresponding to the packet matching domain information is obtained. The hardware layer sends the packet information and the flow identification information to the fastpath module in the software layer, and the fastpath module looks up the target flow identification information matching the flow identification information and the target execution action information matching the flow identification information, and processes the packet information according to the target execution action information. On one hand, this data processing method can utilize the high computational performance of the hardware layer to complete the fixed and time-consuming processes such as packet parsing and lookup, and hand over the flexible and versatile actions to the software layer, thereby improving processing performance and flexibility. On the other hand, through using batch processing of the packet information by the hardware layer, the software layer can process, based on the execution action information, the packets without dealing with the packets one by one, but performing the same processing on a group of packets with the same flow identification information, which improves processing performance. At the same time, for the hardware layer, since the batch processing is adopted, the performance of forwarding the packet information to the software layer is further improved.

### BRIEF DESCRIPTION OF DRAWINGS

FIG. 1 is a schematic diagram illustrating evolution stages of a smart network interface card in related art.

FIG. 2 is a structural schematic diagram of a smart network interface card according to a first embodiment of the present disclosure.

FIG. 3 is a flowchart of a data processing method according to a first embodiment of the present disclosure.

FIG. 4 is a schematic diagram illustrating a batch processing way in a data processing method according to some embodiments of the present disclosure.

FIG. 5 is a structural schematic diagram of a smart network interface card according to a second embodiment of the present disclosure.

FIG. 6 is a flowchart of a data processing method according to a second embodiment of the present disclosure.

FIG. 7 is a flowchart of a data processing method according to a third embodiment of the present disclosure.

FIG. 8 is a flowchart of a data processing method according to a fourth embodiment of the present disclosure.

FIG. 9 is a structural schematic diagram of an electronic device according to some embodiments of the present disclosure.

### DETAILED DESCRIPTION OF THE INVENTION

In the following description, many specific details are set forth to provide a thorough understanding of the present disclosure. However, the present disclosure can be implemented in many different ways not specifically described herein, and a person skilled in the art can make similar extensions without departing from the essence of the present disclosure. Therefore, the specific implementations disclosed herein are not intended to limit the present disclosure.

The terms used in the present disclosure are for the purpose of describing specific embodiments and are not intended to limit the present disclosure. The descriptive terms such as “a”, “first”, and “second” used in the present disclosure and the appended claims are not intended to limit the quantity or order but are used for distinguishing information of the same type.

Based on the related art described above, it is known that a smart network interface card plays a crucial role in processing speed and forwarding logic performance of a Central Processing Unit (CPU). Therefore, how the smart network interface card achieves hardware offloading and performance improvement will be described below in conjunction with the related art.

First, an explanation of a smart network interface card is provided. According to the aforementioned related art, a smart network interface card can be categorized into a basic function network interface card, a first-generation a smart network interface card, and a second-generation DPU smart network interface card based on the development stages of the smart network interface card.

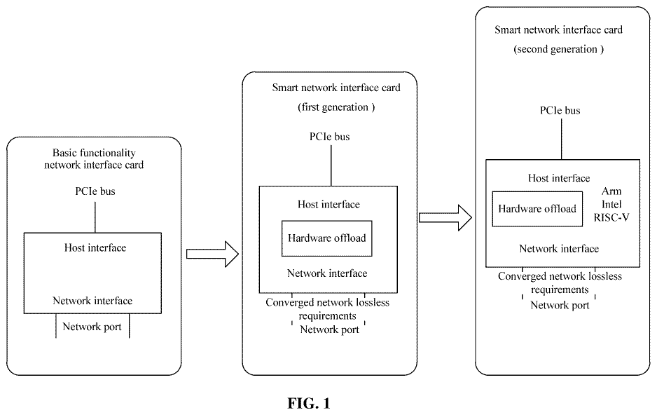

As shown in FIG. 1, FIG. 1 is a schematic diagram illustrating evolution stages of a smart network interface card in related art. The basic function network interface card (also known as ordinary network interface card) provides 2×10 G or 2×25 G bandwidth throughput with limited hardware offloading capability, mainly including Checksum, Large Receive Offload (LRO)/Large Segment Offload (LSO), supports for Single Root I/O Virtualization (SR-IOV), and limited multi-queue capability. In a cloud platform virtualized network, the basic function network interface card provides network access to a virtual machine (VM) in three ways. One, an operating system kernel driver manages the network interface card and distributes network traffic to the VM. Two, Open vSwitch and Data Plane Development Kit (OVS-DPDK) manages the network interface card and distributes network traffic to the VM. Three, in a high-performance scenario, the SR-IOV provides a network access capability to the VM.

A first-generation smart network interface card (also known as hardware offloading network interface card) has rich hardware offloading capability, for example, Remote Direct Memory Access (RDMA) network hardware offloading based on RDMA over Converged Ethernet (RoCEv1) and RoCEv2, hardware offloading of lossless network capability in a converged network, such as Priority-based Flow Control (PFC), Explicit Congestion Notification (ECN), Enhanced Transmission Selection (ETS) etc., hardware offloading of non-volatile memory express over Fabrics (NVMe-oF) in a storage domain, and data plane offloading for secure transmission. The first-generation smart network interface card primarily focuses on data plane offloading to accelerate a critical task in a data center application, such as security, virtualization, Software Defined Network (SDN)/Network Function Virtualization (NFV), big data, machine learning, and storage.

The second-generation smart network interface card (also known as DPU) is a specialized processor constructed around data-centric architecture, using software-defined technology to support infrastructure layer resource virtualization, and support storage, security, quality of service management, and other infrastructure layer services. The second-generation smart network interface card is identified as the “third main chip” in a data center after the CPU and a graphics processing unit (GPU). The DPU has a peripheral component interconnect express (PCIe) network interface card device with high-performance “CPU+programmable hardware” forwarding IO data plane acceleration. Therefore, the second-generation smart network interface card (namely DPU) is also be referred to as a programmable smart network interface card. The DPU builds a bus system, operates independently of a host CPU, and further controls and manages other devices. The DPU offloads a task typically handled by a system CPU, supports offloading and acceleration for various general-purpose tasks, and enables elastic acceleration scenarios such as container environment, load balancing, network security, and advanced customized networking.

Secondly, how a smart network interface card (namely DPU) can reduce CPU load, improve overall data center performance, and enhance CPU processing speed for the present disclosure task will be described below in conjunction with the related art.

Based on the related art, due to the slowdown of Moore's Law, the marginal cost of increasing general-purpose CPU performance has risen sharply. To address the evolution of network bandwidth from mainstream 10 G towards 25 G, 40 G, 100 G, 200 G, and even 400 G, network virtualization processing is offloaded to the DPU smart network interface card to enhance CPU performance. One of the most typical examples is offloading a virtual switch (vswitch) to the DPU smart network interface card.

In the related art, the software vswitch processing of the CPU in the DPU smart network interface card is divided into two parts: a slowpath and a fastpath. The slowpath includes a complete processing flow of a data packet, such as routing, Access Control List (ACL), rate limiting, etc. Typically, the initial packet of a data flow goes through the complete processing of the slowpath. After the initial packet goes through the slowpath, a forwarding flow entry is generated based on results of the routing, the ACL, the rate limiting, and other logical operations. A flow entry includes packet matching domain information and execution action information. The packet matching domain information includes packet data information, such as five-tuple information, while the execution action information includes operations performed on the packet, such as encapsulation/de-encapsulation, forwarding, rate limiting, etc. A subsequent packet first look up the forwarding flow table in the fastpath. When a corresponding flow entry is found, the subsequent packet is directly processed based on the execution action information in the forwarding flow table, thereby improving processing performance. Additionally, the slowpath simultaneously issues a flow entry to the fastpath and the hardware in the DPU smart network interface card. Therefore, there are identical flow tables in both software and hardware. When the packet hits the flow table in the hardware first, the packet is directly processed by the hardware according to the action in the flow table, further enhancing processing performance.

The above describes the reasons why the DPU smart network interface card can reduce CPU load and improve CPU performance in forwarding logic.

However, due to the rapid iteration and evolution of network services in the related art, it is necessary to add and/or modify the forwarding action, thereby requiring the fastpath to have strong flexibility. The hardware part of the DPU smart network interface card cannot meet this flexibility requirement since the hardware in the DPU smart network interface card is typically not modifiable. For example, when the hardware uses Application Specific Integrated Circuit (ASIC), the DPU smart network interface card cannot modify the action. Even in response to using Field Programmable Gate Array (FPGA), the DPU smart network interface card is limited by factors such as development cycle and hardware resource, making it unable to support flexible and varied action.

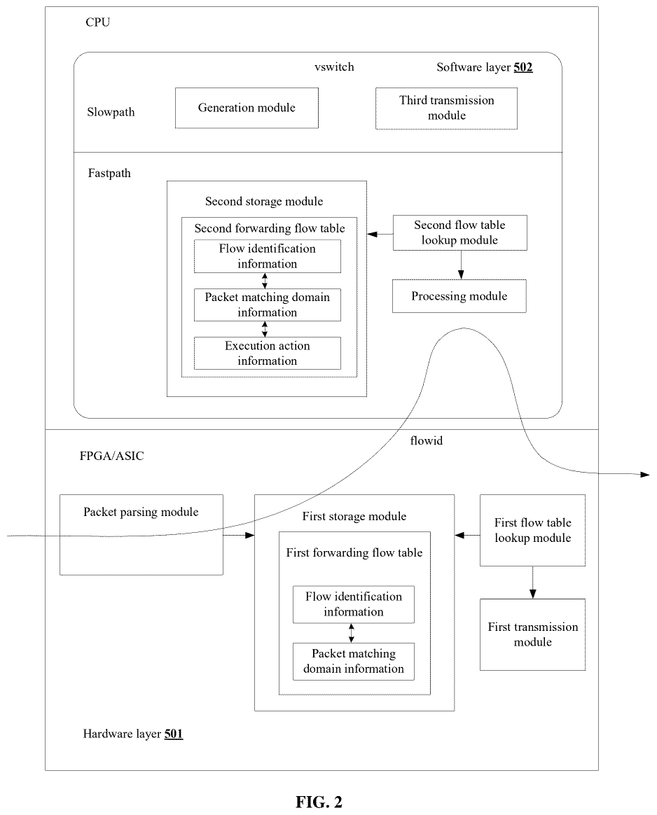

Based on this, the present disclosure provides a smart network interface card, as shown in FIG. 2. FIG. 2 is a structural schematic diagram of a smart network interface card according to some embodiments of the present disclosure. In some embodiments, the DPU smart network interface card includes a hardware layer 201 and a software layer 202.

The hardware layer is a Field Programmable Gate Array (FPGA) or an Application Specific Integrated Circuit (ASIC). Specifically, the hardware layer includes a packet parsing module, a first storage module, a first flow table lookup module, and a first transmission module. The packet parsing module is arranged for parsing a packet to obtain packet information. The first storage module is arranged for storing a first forwarding flow table, the first forwarding flow table includes flow identification information (namely flow id) and packet matching domain information corresponding to the flow identification information, but the first forwarding flow table does not include execution action information corresponding to the packet matching domain information. The first flow table lookup module is arranged for looking up the packet matching domain information corresponding to the packet information and the flow identification information corresponding to the packet matching domain information from the first forwarding flow table. The first transmission module is arranged for sending the flow identification information found by the first flow table lookup module and the packet information to the fastpath module in the software layer.

In some embodiments, the flow identification information and the packet matching domain information corresponding to the flow identification information in the first forwarding flow table are set as a forwarding flow entry of one packet. The forwarding flow entry does not include the execution action information. That is, the first forwarding flow table includes the flow identification information and the packet matching domain information, but does not include the execution action information. The packet matching domain information is used for recording the packet information after parsing the packet, such as the five-tuple of the packet, including source/destination Internet Protocol (IP) address, source/destination port, protocol, etc., which are not exhaustively listed here.

The software layer is software on the CPU, such as a virtual switch (vswitch), an operating system (OS) and so on. In some embodiments, the software layer includes a fastpath module; the fastpath module includes a second storage module, a second flow table lookup module, and a processing module. The second storage module stores a second forwarding flow table. The second forwarding flow table includes flow identification information (namely flow id), packet matching domain information corresponding to the flow identification information, and execution action information corresponding to the packet matching domain information. The second flow table lookup module is arranged for looking up target flow identification information matching the flow identification information sent by the first transmission module from the second forwarding flow table. The processing module is arranged for processing the received packet information according to the execution action information corresponding to the target flow identification information. In some embodiments, each forwarding flow entry in the second forwarding flow table includes the flow identification information (namely flow id), the packet matching domain information corresponding to the flow identification information, and the execution action information corresponding to the packet matching domain information, i.e., the second forwarding flow table stores the flow identification information, the packet matching domain information, and the execution action information. The execution action information is used for recording information obtained by processing the packet information, such as encapsulation/de-encapsulation, forwarding, rate limiting, etc., which are not exhaustively listed here.

The software layer further includes a slowpath module. The slowpath module includes a generation module and a third transmission module. The generation module is arranged for generating a third forwarding flow entry in response to the first forwarding flow table not containing the packet matching domain information matching the packet information or in response to the packet being an initial packet. The third forwarding flow entry includes the packet matching domain information corresponding to at least one of the packet information and the initial packet, the flow identification information (flow id) corresponding to the packet matching domain information, and the execution action information (action) corresponding to the packet matching domain information. The third transmission module is arranged for sending the flow identification information and the packet matching domain information in the third forwarding flow entry to the first storage module in the hardware layer and sending the third forwarding flow entry to the second storage module in the fastpath module.

It should be noted that in response to the first forwarding flow table not containing the packet matching domain information matching the packet information, the packet is the initial packet, or the packet matching domain information cannot be found from the first forwarding flow table in the hardware layer due to abnormal packet parsing or abnormal first forwarding flow table.

In some embodiments, the slowpath module includes a complete processing flow for a data packet, such as routing, ACL, rate limiting, etc. Typically, the initial packet of a data flow goes through the complete processing of the slowpath. After the initial packet goes through the slowpath, the slowpath module generates a forwarding flow entry based on multiple logical results such as the routing, the ACL, the rate limiting and so on. The forwarding flow entry includes a flowid part, a match part, and an action part. The match part includes the packet information (such as packet five-tuple: source/destination IP, source/destination port, protocol, etc.), while the action part includes action information to be performed on the packet, such as encapsulation/de-encapsulation, forwarding, rate limiting, etc. The slowpath issues the flow entry to both the fastpath and the hardware layer. The first forwarding flow table stored in the hardware layer differs from the second forwarding flow table stored in the fastpath in that the first forwarding flow table in the hardware layer stores the flowid part and the match part, without the corresponding action part. The similarities lie in that the first forwarding flow table and the second forwarding flow table store the same flowid part and the same match part for the same packet.

To further enhance the processing performance of the smart network interface card and reduce CPU load, the hardware layer further include a data cache. The data cache includes multiple data cache queues, arranged for caching the packet information that has completed the lookup in the first forwarding flow table in pre-set batches, and caching the packet information with the same flow identification information in the same data cache queue. In some embodiments, the pre-set batches refer to a batch processing way, the number of packets per batch is set according to processing requirements. For instance, the batches can be pre-set, or the batches can be real-time set based on the processing capability of the smart network interface card, or the batches can be real-time set based on the CPU load. The number of packets of each batch can be set, and the present disclosure does not limit the batches for obtaining packets or the number of packets. Additionally, in some embodiments, the packets are obtained in the batch processing way, or batch acquisition is performed according to a set time period, or of course, the batch acquisition is further set based on related information such as processing requirements. Regarding the batch processing way, a detailed description will be provided in the following data processing method embodiment. Please refer to the subsequent content.

Based on the batch processing way, the first transmission module in the hardware layer is arranged for simultaneously sending the packet information and the flow identification information of the same group of packets stored in the same data cache queue to the fastpath module in the software layer.

The processing module in the fastpath module looks up the target flow identification information from the second forwarding flow table and performs the same processing on the packet information in the same data cache queue based on the target execution action information corresponding to the target flow identification information. To improve forwarding performance, the packet information and flow identification information of the same group of packets are sent to the fastpath module in vector form. Identification information (vector1) of a vector corresponds to the same flow identification information (flowid1). The fastpath module looks up the target flow identification information matching the identification information of the vector from the second forwarding flow table, and processes the packet information of the same group of packets according to the target execution action information corresponding to the target flow identification information. For more details, please refer to the content of the data processing method embodiment.

The above is a description of the smart network interface card according to the first embodiment of the present disclosure. In this embodiment, the smart network interface card is capable of parsing and looking up the packet in the hardware layer. After looking up the packet matching domain information and the flow identification information corresponding to the packet matching domain information based on the packet information, the smart network interface card sends the flow identification information and the packet information to the fastpath module in the software layer. In response to the fastpath module looking up the target flow identification information based on the flow identification information, the smart network interface card determines the target execution action information and processes the packet information according to the target execution action information. During the processing of the packet, the smart network interface card can complete the fixed and time-consuming processes such as packet parsing and flow identification lookup through the hardware layer, and process the flexible and versatile execution action information through the software layer, thereby ensuring effectiveness, improving processing performance and further maintaining flexibility. In addition, through the batch processing way for the packet, the hardware layer can divide the packet information with the same flow identification information into the same group, so as to forward to the software layer in group, thereby improve the forwarding performance of the hardware layer. The software layer can process the same group of the packet information based on the same execution action information, which further improves processing performance.

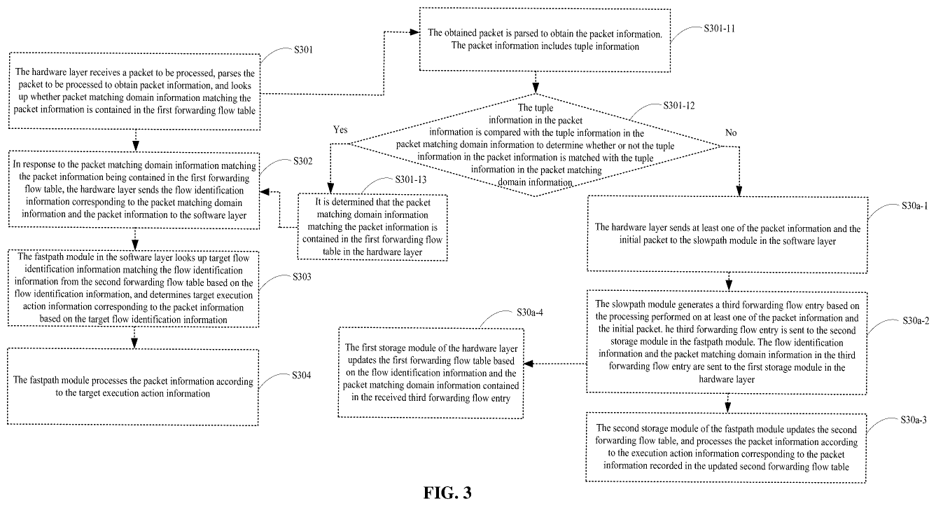

Based on the above, some embodiments of the present disclosure further provide a data processing method. As shown in FIG. 3, FIG. 3 is a flowchart of a data processing method according to a first embodiment of the present disclosure. The first embodiment of this method is primarily described using a smart network interface card as an example. It should be understood that the software layer and hardware layer in this and subsequent embodiments can be processed by different devices separately or by other hardware devices, such as hardware gateway devices, hardware load balancing devices, etc. Therefore, the hardware layer and the software layer are not limited to being set up on the smart network interface card but can also be set up on other hardware devices or arranged on different hardware devices. The first embodiment of the data processing method includes the following steps.

In step S301, the hardware layer receives a packet to be processed, parses the packet to be processed to obtain packet information, and looks up whether packet matching domain information matching the packet information is contained in the first forwarding flow table.

In step S302, in response to the packet matching domain information matching the packet information being contained in the first forwarding flow table, the hardware layer sends the flow identification information corresponding to the packet matching domain information and the packet information to the software layer.

In step S303, the fastpath module in the software layer looks up target flow identification information matching the flow identification information from the second forwarding flow table based on the flow identification information, and determines target execution action information corresponding to the packet information based on the target flow identification information.

In step S304, the fastpath module processes the packet information according to the target execution action information.

Detailed description of each step are introduced as below.

In step S301, the hardware layer receives a packet to be processed, parses the packet to be processed to obtain packet information, and looks up whether packet matching domain information matching the packet information is contained in the first forwarding flow table.

The packet information in step S301 is five-tuple information of the packet, such as source/destination IP address, source/destination port, protocol, etc. The packet information is packet information in the data stream, where the packet is a data unit used for switching and transmission in the network and is further a unit of network transmission. The packet information includes complete data information to be sent, which can vary in length. During transmission, the packet information is encapsulated into segments, packets, frames, etc., by adding control information in a header, i.e., a packet header. The packet is known in the related art and will not be elaborated here.

In some embodiments, the hardware layer being an FPGA or ASIC chip and the software layer being a virtual switch (vswitch) are taken as an example for illustration.

The specific implementation process of step S301 includes the following steps.

In step S301-11, the obtained packet is parsed to obtain the packet information. The packet information includes tuple information.

In step S301-12, the tuple information in the packet information is compared with the tuple information in the packet matching domain information to determine whether or not the tuple information in the packet information is matched with the tuple information in the packet matching domain information.

In step S301-13, in response to the tuple information in the packet information being matched with the tuple information in the packet matching domain information, it is determined that the packet matching domain information matching the packet information is contained in the first forwarding flow table in the hardware layer.

In some embodiments, in step S301-11, the hardware layer parses the packet to obtain the tuple information in the packet information, and the tuple information is five-tuple information of the packet, such as, source IP address information, destination IP address information, source port information, destination port information, protocol information, etc.

In step S301-12, the source IP address information and the destination IP address information in the five-tuple is compared with the source IP address information and the destination IP address information recorded in the packet matching domain information of the first forwarding flow table in the hardware layer to determine whether there are identical source IP address information and destination IP address information.

For example, the first forwarding flow table is in the following form:

| flowid (flow | |
|---|---|
| identification | |
| information) | match (packet matching domain information) |
| 1 | 1.1.1.1:80 (source ip)→2.2.2.2:90 (destination ip) |
| 2 | 1.1.1.1:90 (source ip)→2.2.2.2:90 (destination ip) |
| 3 | 1.1.1.2:90 (source ip)→2.2.2.2:90 (destination ip) |

In the five-tuple information, the source IP address information is 1.1.1.1:90 and the destination IP address information is 2.2.2.2:90, which are matched with the source IP address information being 1.1.1.1:90 and the destination IP address information being 2.2.2.2:90 in the packet information.

It should be noted that the above description of the packet matching domain information uses the source IP address information and the destination IP address information as an example. In practice, the packet matching domain information further includes other information, such as source port, destination port, protocol type including Transmission Control Protocol (TCP)/User Datagram Protocol (UDP)/Internet Control Message Protocol (ICMP), etc. Other information further includes tunnel information, etc., i.e., information in the packet. The table above is an example and does not limit the information stored in the packet matching domain information.

In step S302, in response to the packet matching domain information matching the packet information being contained in the first forwarding flow table, the hardware layer sends the flow identification information corresponding to the packet matching domain information and the packet information to the software layer.

The specific implementation process of step S302 is as follows. Based on a result of step S301 indicating that the packet matching domain information matching the packet information is contained in the first forwarding flow table, the flow identification information corresponding to the packet matching domain information is determined according to the packet matching domain information found in the hardware layer, and then the flow identification information and the packet information are sent to the software layer. Following the previous example, the information of flowid=2 and the packet information are sent to the fastpath module in the software layer.

The above describes the execution of step S302 in response to the result of step S301 being positive.

Furthermore, it should be understood that the result of step S301 can further be negative, thus this embodiment further includes the following steps.

In step S30a-1, in response to a lookup result of the first forwarding flow table indicating that the packet matching domain information matching the packet information is not contained in the first forwarding flow table, or in response to the packet to be processed being the initial packet, the hardware layer sends at least one of the packet information and the initial packet to the slowpath module in the software layer.

In step S30a-2, the slowpath module generates a third forwarding flow entry based on the processing performed on at least one of the packet information and the initial packet. The third forwarding flow entry includes: the packet matching domain information corresponding to at least one of the packet information and the initial packet, the flow identification information corresponding to the packet matching domain information and the execution action information corresponding to the packet matching domain information. The third forwarding flow entry is sent to the second storage module in the fastpath module. The flow identification information and the packet matching domain information in the third forwarding flow entry are sent to the first storage module in the hardware layer. Typically, in response to the packet information being the initial packet, the packet matching domain information matching the packet information is not contained in the first forwarding flow table. However, there can also be some abnormal situations, such as the update of at least one of the first forwarding flow table and the second forwarding flow table fails or the record of at least one of the first forwarding flow table and the second forwarding flow table is abnormal, etc. Therefore, whether for the initial packet information or for packet information with abnormal, in response to the packet matching domain information matching the packet information being not contained in the first forwarding flow table, the hardware layer will send the initial packet and the packet information to the software layer. The slowpath module in the software layer processes the packet information to generate the third forwarding flow entry based on processing logics including routing, Access Control List (ACL), rate limiting, etc.

In step S30a-3, the second storage module of the fastpath module updates the second forwarding flow table based on the received third forwarding flow entry, and processes the packet information according to the execution action information corresponding to the packet information recorded in the updated second forwarding flow table.

In step S30a-4, the first storage module of the hardware layer updates the first forwarding flow table based on the flow identification information and the packet matching domain information contained in the received third forwarding flow entry.

In some embodiments, the fastpath module updates the second forwarding flow table based on the third forwarding flow entry provided by the slowpath module, and the hardware layer updates the first forwarding flow table based on the third forwarding flow entry provided by the slowpath module. The specific form of the packet-related information issued by the slowpath module in the software layer is not limited, so the way of updating the second forwarding flow table by the fastpath module in the software layer is not limited, and the way of updating the first forwarding flow table by the hardware layer is further not limited, as long as the packet matching domain information and the flow identification information recorded for the same packet information are the same in both the first forwarding flow table and the second forwarding flow table.

In some embodiments, the flow identification information, the packet matching domain information, and the execution action information in the third forwarding flow entry are recorded in the second forwarding flow table, and the flow identification information and the packet matching domain information in the third forwarding flow entry are recorded in the first forwarding flow table. The second forwarding flow table is stored in the second storage module of the fastpath module, while the first forwarding flow table is stored in the first storage module of the hardware layer. Of course, the slowpath module further stores the relevant information in the third forwarding flow entry. Although the categories of the third forwarding flow table entry contained in the first forwarding flow table and the second forwarding flow table are different, the information corresponding to the same packet in the same category is the same. For example, in this embodiment, the third forwarding flow entry in the first forwarding flow table includes the flow identification information and the packet matching domain information for packet information A; and the third forwarding flow entry in the second forwarding flow table includes the flow identification information, the packet matching domain information, and the execution action information for packet information A. Therefore, the flow identification information and the packet matching domain information for packet information A are the same in both the first forwarding flow table and the second forwarding flow table.

In step S30a-3, the fastpath module processes the packet information includes that: the fastpath module processes the packet information based on the execution action information corresponding to the packet matching domain information recorded in the updated second forwarding flow table. Therefore, even if the matching packet matching domain information is contained in the hardware layer, the packet information can still be processed accordingly in the fastpath module of the software layer, ensuring the real-time processing of the packet information and improving CPU performance.

The steps from S30a-1 to S30a-4 mainly describe the processing of packet information in response to the result in step S301 is negative.

In step S303, the fastpath module in the software layer looks up target flow identification information matching the flow identification information from the second forwarding flow table based on the flow identification information, and determines target execution action information corresponding to the packet information based on the target flow identification information.

Based on the descriptions of step S301 and step S302, it is known that the first forwarding flow table in the hardware layer stores the flow identification information and the packet matching domain information, while the second forwarding flow table in the software layer stores the flow identification information, the packet matching domain information, and the execution action information. The second forwarding flow table in the software layer is as shown in the following table:

| | | Action |
|---|---|---|
| flowid (flow | | (execution |
| identification | match (packet matching domain | action |
| information) | information) | information) |
| 1 | 1.1.1.1:80 (source ip)→2.2.2.2:90 | vxlan encap |
| | (destination ip) | (encapsulation) |
| 2 | 1.1.1.1:90 (source ip)→2.2.2.2:90 | nat (forwarding) |
| | (destination ip) | |
| 3 | 1.1.1.2:90 (source ip)→2.2.2.2:90 | Output port2 |
| | (destination ip) | (output port) |

The specific implementation process of step S303 includes the following steps.

In step S303-11, the fastpath module in the software layer determines the target flow identification information corresponding to the flow identification information in the second forwarding flow table based on the flow identification information. Continuing with the previous example, in response to the flow identification information sent in step S302 is 2 (i.e., flowid=2), the fastpath module looks up the value of flowid=2 in the stored second forwarding flow table and determines flowid=2 as the target flow identification information. The fastpath module then determines the execution action information nat (forwarding) corresponding to the target flow identification information as the target execution action information (as shown in the third row of the above table).

In step S304, the fastpath module processes the packet information according to the target execution action information.

The purpose of step S304 is to perform the execution action information on the packet information based on the target execution action information. Since the software layer has obtained the flow identification information in step S303, the target execution action information is directly determined based on the target flow identification information matching the flow identification information and the corresponding actions are directly performed on the packet information without parsing and looking up the packet, thereby improving the processing efficiency of the packet information and enhancing the processing performance of the smart network interface card since the parsing and lookup operations are performed by the hardware layer.

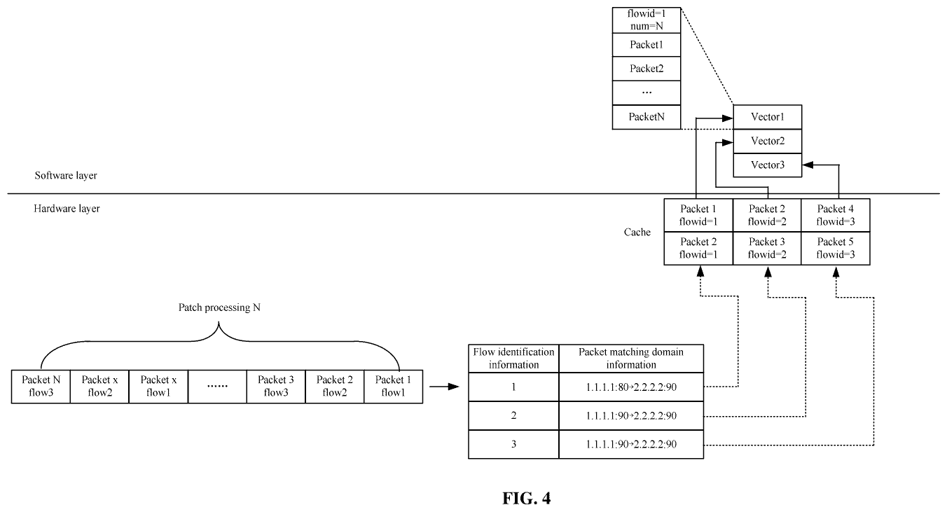

Based on the above, to further enhance the processing performance of the smart network interface card and reduce CPU load, a processing way for the packet information includes a batch processing way. As shown in FIG. 4, FIG. 4 illustrates a batch processing way in a data processing method according to some embodiments of the present disclosure, the specific implementation process of batch processing includes the following steps.

In step S30-b1, the hardware layer divides the packet information that has completed the lookup in the first forwarding flow table in pre-set batches into the same group of packets according to the same flow identification information, and caches the packet information of the same group of packets in a data cache queue of the hardware layer, where the packet information with the same flow identification information is cached in the same data cache queue.

Typically, a data stream includes multiple pieces of packet information, and a first packet information is the initial packet. Each data stream in multiple data streams includes the multiple pieces of packet information. The patches of the batch processing way for obtaining the packets can be pre-set, or the batches can be set in real-time based on the processing capability of the smart network interface card, or the batches can be set in real-time based on the CPU load. This embodiment does not limit whether the batches can be pre-set or set in real-time. The batch processing can be triggered based on a set time period or combined with other processing requirements. The acquisition of multiple packets can be obtained based on different data streams or the same data stream, for example, 64 pieces of packet information or 64 packets.

In step S30-b1, the same packet information is stored as the same group of packets in a ring buffer of the hardware layer, in a queue format. For example, as shown in FIG. 3, a packet 1 and a packet 2 belonging to flowid1 are grouped together and stored in the first column of the ring cache, in the queue format. A packet 1 and a packet 2 belonging to flowid2 are grouped together and stored in the second column of the ring cache, in the queue format. A packet 1 and a packet 2 belonging to flowid3 are grouped together and stored in the third column of the ring cache, in the queue format.

In step S30-b1, it is determined whether or not, after parsing the packet obtained in the in pre-set batches to obtain the packet information, the packet matching domain information is contained in the first forwarding flow table stored in the hardware layer. That is, it determines whether or not the packet matching domain information corresponding to each piece of packet information in the multiple pieces of packet information is contained in the first forwarding flow table. Similarly, the tuple information in the packet information is compared with the packet matching domain information in the first forwarding flow table to group to set the packet information with the same flow identification information as the same group of packets and store the packet information with the same flow identification information in the data cache queue of the hardware layer.

In step S30-b2, the flow identification information and the packet information of the same group of packets are simultaneously sent to the fastpath module.

In step S30-b3, the fastpath module looks up the target flow identification information matching the flow identification information from the second forwarding flow table based on the flow identification information, and processes the packet information of the same group of packets based on the target execution action information, determined according to the target flow identification information, corresponding to the packet information of the same group of packets.

The specific implementation process of step S30-b2 includes the following steps.

The flow identification information of the same group of packets is sent to the fastpath module in vector form, where a vector includes the same flow identification information of the same group of packets.

The specific implementation process of step S30-b3 includes the following steps.

The fastpath module looks up the target flow identification information matching the same flow identification information from the second forwarding flow table based on the same flow identification information, and processes the packet information of the same group of packets based on the target execution action information corresponding to the target flow identification information.

Continuing with the example of the packet and flow identification information, in step S30-b1, a vector of one group of packets including a packet 1 and a packet 2 is a vector1, where the same flow identification information in the vector1 is flowid=1. A vector of one group of packets including a packet 3 and a packet 4 is a vector2, where the same flow identification information in the vector2 is flowid=2. A vector of one group of packets including a packet 5 and a packet 6 is a vector3, where the same flow identification information in the vector3 is flowid=3.

The vector1 includes the packet information of the packet 1 and the packet 2, and the same flow identification information flowid1. The initial packet of this groups of packets in the vector1 records the packet number (such as, 2) of this groups of packets.

The vector2 includes the packet information of the packet 1 and the packet 2, and the same flow identification information flowid2. The initial packet of this groups of packets in the vector2 records the packet number (such as, 2) of this groups of packets.

The vector3 includes the packet information of the packet 1 and the packet 2, and the same flow identification information flowid3. The initial packet of this groups of packets in the vector3 records the packet number (such as, 2) of this groups of packets. The above examples use packets 1 to 6 for illustration and do not limit the number of packets processed.

Through recording the number of packets, the processing progress, and/or the timing for switching from the first column to the second column or from the first group of packets to the second group of packets can be acquired. Additionally, it is clear from the content of the vector mentioned above that the packets belonging to the same group share the same flowid.

Continuing with the pervious example, in step S30-b2, the vector1, the vector2, and the vector3 are sent to the fastpath module in the software layer, which can be done simultaneously or separately. In response to using a separate sending way, the sending of the next group of packets is triggered based on a processing state of the sending of the previous group of packets. The specific sending way is not limited.

Therefore, in step S303, the fastpath module in the software layer looks up the target flow identification information matching the flow identification information in the second forwarding flow table based on the flow identification information, and determines the target execution action information corresponding to the packet information based on the target flow identification information. This process specifically includes the following steps.

In step S303-21, the software layer determines the target flow identification information from the second forwarding flow table based on the same flow identification information in the vector.

In step S303-22, the execution action information corresponding to the target flow identification information in the second forwarding flow table is determined as the target execution action information corresponding to the packet information of the same group of packets.

Based on this, the specific process of step S304 includes the following steps.

In step S304-21, the fastpath module in the software layer processes the packet information of the same group of packets with the same flow identification information based on the target execution action information. Since each vector includes the same flow identification information, the fastpath module is not required to sequentially look up the flow identification information for each packet in the same group. Instead, the fastpath module looks up based on the same flow identification information in the vector and processes the packet information of the same group of packets using the target execution action information corresponding to the same flow identification information, thereby improving the processing performance of the software layer and further enhancing the forwarding performance of the flow identification information and the packet information forwarded by the hardware layer.

It should be noted that the data processing method described in some embodiments is not limited to the smart network interface card. In scenarios combining software and hardware to enhance CPU performance, the software layer and the hardware layer can be deployed on hardware devices other than the smart network interface card, such as hardware gateway devices, hardware load balancing devices, and hardware auxiliary processing devices.

The above is a description of the data processing method according to the first embodiment of the present disclosure. This method uses flowid to distinguish packet information and records the packet matching domain information and the flow identification information in the first forwarding flow table stored in the hardware layer. Since the hardware layer has certain limitations in handling the execution action information due to lack of flexibility, the first forwarding flow table in the hardware layer does not store the execution action information. In some embodiments, in response to the packet matching domain information matching the packet information is contained in the hardware layer, the flow identification information and the packet information corresponding to the packet matching domain information are sent to the software layer. The software layer then looks up the target flow identification information corresponding to the flow identification information and determines the target execution action information corresponding to the target flow identification information, and processes the packet information based on the target execution action information. On one hand, the hardware layer can complete the fixed and time-consuming processes such as packet parsing and lookup, and the fastpath module of the software layer can process the flexible and versatile execution action information, thereby improving processing performance and further maintaining flexibility of the smart network interface card. On the other hand, through the batch processing way for the packet information performed by the hardware layer, the forwarding performance for the packet information of the hardware layer can be improved and the processing performance of the software layer can be further improved.

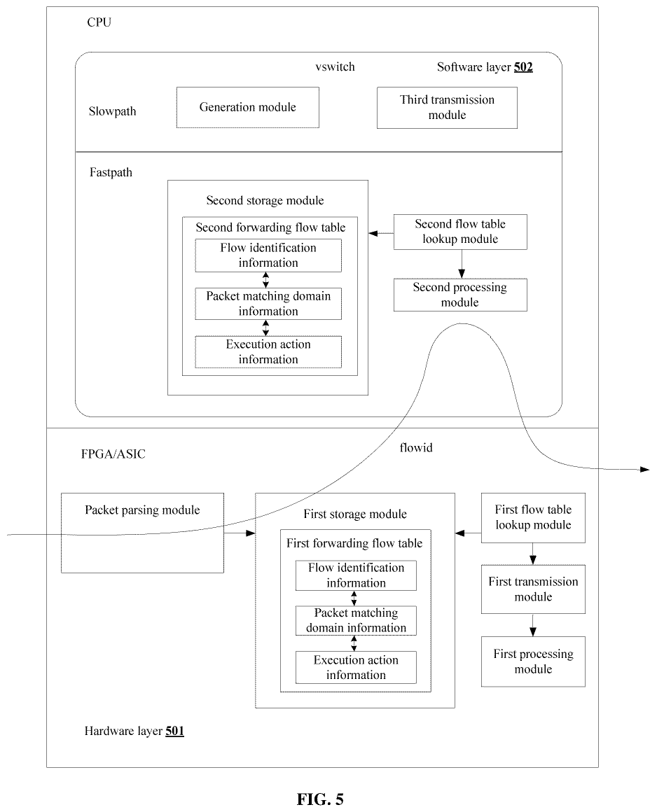

The above describes the data processing method according to the first embodiment of the present disclosure. Based on this, some embodiments of the present disclosure further provide a smart network interface card. Please as shown in FIG. 5, FIG. 5 is structural schematic diagram of a smart network interface card according to a second embodiment of the present disclosure. The smart network interface card includes: a hardware layer 501 and a software layer 502.

The hardware layer includes a packet parsing module, a first storage module, a first flow table lookup module, a first transmission module, and a first processing module; where the packet parsing module is arranged for parsing a packet to obtain packet information; the first storage module is arranged for storing a first forwarding flow table, the first forwarding flow table includes flow identification information, packet matching domain information corresponding to the flow identification information, and execution action information corresponding to the packet matching domain information; the first flow table lookup module is arranged for looking up the packet matching domain information matching the packet information, and the flow identification information corresponding to the packet matching domain information from the first forwarding flow table; the first processing module is arranged for processing the packet information based on the execution action information in response to the first forwarding flow table including the execution action information corresponding to the flow identification information; the first transmission module is arranged for sending the flow identification information and the packet information to a fastpath module in the software layer in response to the first forwarding flow table not containing the execution action information corresponding to the flow identification information.

The software layer includes the fastpath module, the fastpath module includes a second storage module, a second flow table lookup module, and a second processing module; the second storage module is arranged for storing a second forwarding flow table, the second forwarding flow table includes the flow identification information, the packet matching domain information corresponding to the flow identification information, and the execution action information corresponding to the packet matching domain information; the second flow table lookup module is arranged for looking up the target flow identification information matching the flow identification information sent by the first transmission module from the second forwarding flow table; the second processing module is arranged for processing the packet information based on the target execution action information corresponding to the target flow identification information.

The differences between the second embodiment of the smart network interface card shown in FIG. 5 and the first embodiment of the smart network interface card shown in FIG. 2 are as follows.

In terms of structure, the hardware layer in the first embodiment does not include the first processing module, whereas the hardware layer in the second embodiment includes the first processing module.

In terms of function, the first forwarding flow table in the hardware layer in the first embodiment stores the flow identification information and the packet matching domain information, excluding the execution action information. The first forwarding flow table in the hardware layer in the second embodiment includes the flow identification information, the packet matching domain information, and the execution action information. In the second embodiment, when the hardware layer looks up the packet matching domain information for the parsed packet information from the first forwarding flow table, the hardware layer determines whether or not the first forwarding flow table contains the execution action information. In response to the first forwarding flow table containing the execution action information, the hardware layer processes the packet information based on the execution action information. In response to the first forwarding flow table not containing the execution action information, the hardware layer sends the flow identification information corresponding to the packet matching domain information and the packet information to the fastpath module in the software layer, so that when the hardware layer has the processing ability of the execution action information and the first forwarding flow table contains the execution action information matching the packet information, the hardware layer can process the packet information, and when the hardware layer has the processing ability of the execution action information and the first forwarding flow table does not contain the execution action information matching the packet information, the packet information is sent to the fastpath module in the software layer for processing.

The first transmission module is further arranged for sending the packet information to a slowpath module in the software layer in response to the first forwarding flow table not containing the packet matching domain information corresponding to the packet information.

In the second embodiment, the software layer further includes the slowpath module. The slowpath module includes a generation module and a third transmission module. The generation module is arranged for generating a third forwarding flow entry based on the processing performed on the packet information in response to the first forwarding flow table not containing the packet matching domain information matching the packet information, and/or in response to the packet being an initial packet. The third forwarding flow entry includes the packet matching domain information corresponding to at least one of the packet information and the initial packet, the flow identification information corresponding to the packet matching domain information, and the execution action information corresponding to the packet matching domain information. The third transmission module is arranged for sending the third forwarding flow entry to the second storage module, in response to the hardware layer not supporting the processing of the execution action information, sending the flow identification information and the packet matching domain information in the third forwarding flow entry to the first storage module, and in response to the hardware layer supporting the processing of the execution action information, sending the third forwarding flow entry to the first storage module.

In some embodiments, the hardware layer further includes a data cache, the data cache includes multiple data cache queues, arranged for caching the packet information that has completed the lookup in the first forwarding flow table in pre-set batches, and caching the packet information with the same flow identification information in the same data cache queue.

The first transmission module in the hardware layer is arranged for simultaneously sending the packet information and the flow identification information of the same group of packets stored in the same data cache queue to the fastpath module in the software layer.

The processing module in the fastpath module is arranged for looking up target flow identification information from the second forwarding flow table and performing the same processing on the packet information in the same data cache queue based on target execution action information corresponding to the target flow identification information.

Here, the differences between the first embodiment and the second embodiment are described. For other relevant content in the second embodiment, please refer to the above description of the first embodiment, which will not be detailed here.

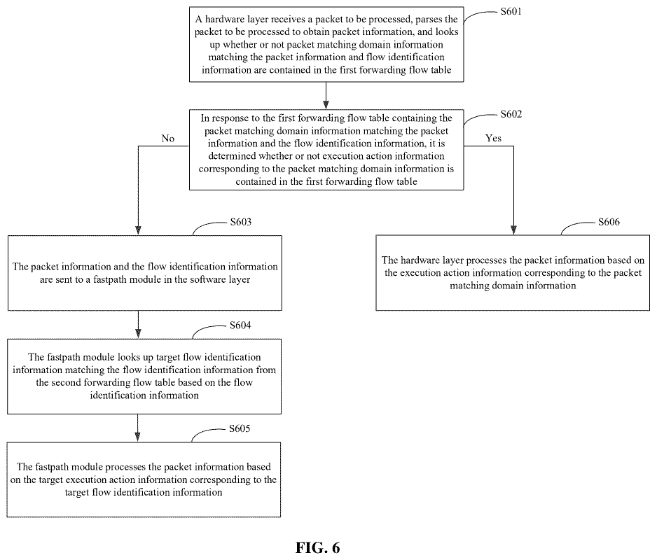

Based on the above second embodiment, some embodiments of the present disclosure further provide a second embodiment of a data processing method, as shown in FIG. 6. The second embodiment of this method is described using a smart network interface card as an example and specifically includes the following steps.

In step S601, a hardware layer receives a packet to be processed, parses the packet to be processed to obtain packet information, and looks up whether or not packet matching domain information matching the packet information and flow identification information are contained in the first forwarding flow table.

In step S602, in response to the first forwarding flow table containing the packet matching domain information matching the packet information and the flow identification information, it is determined whether or not execution action information corresponding to the packet matching domain information is contained in the first forwarding flow table.

In step S603, in response to the first forwarding flow table not containing the execution action information corresponding to the packet matching domain information, the packet information and the flow identification information are sent to a fastpath module in the software layer.

In step S604, the fastpath module looks up target flow identification information matching the flow identification information from the second forwarding flow table based on the flow identification information.

In step S605, the fastpath module processes the packet information based on the target execution action information corresponding to the target flow identification information.

In step S606, in response to the first forwarding flow table containing the execution action information corresponding to the packet matching domain information, the hardware layer processes the packet information based on the execution action information corresponding to the packet matching domain information.

In the second embodiment of the method, after the hardware layer obtains the packet and parses the packet, the hardware layer looks up the packet matching domain information corresponding to the packet information from the first forwarding flow table in the hardware layer. In response to the hardware layer looking up the packet matching domain information, it is determined whether or not execution action information corresponding to the packet matching domain information is contained in the first forwarding flow table. In response to the first forwarding flow table containing the execution action information corresponding to the packet matching domain information, the hardware layer processes the packet information based on the execution action information. In response to the first forwarding flow table not containing the execution action information corresponding to the packet matching domain information, the hardware layer sends the flow identification information corresponding to the packet matching domain information and the packet information to the fastpath module in the software layer. The fastpath module looks up the target flow identification information based on the flow identification information and processes the packet information based on the target execution action information corresponding to the target flow identification information.

In response to the first forwarding flow table not containing the packet matching domain information corresponding to the packet information, and/or in response to the packet to be processed being an initial packet, at least one of the packet information and the initial packet is sent to a slowpath module in the software layer.

The slowpath module generates a third forwarding flow entry based on the processing performed on at least one of the packet information and the initial packet, and the third forwarding flow entry includes the flow identification information corresponding to at least one of the packet information and the initial packet, the packet matching domain information corresponding to the flow identification information, and the execution action information corresponding to the packet matching domain information.

The third forwarding flow entry is sent to the second storage module, in response to the hardware layer not supporting the processing of the execution action information, the flow identification information corresponding to the packet information and the packet matching domain information corresponding to the flow identification information from the third forwarding flow entry are sent to the first storage module, and in response to the hardware layer supporting the processing of the execution action information, the third forwarding flow entry is sent to the first storage module.

Compared with the first embodiment, the main difference in the second embodiment is that the first forwarding flow table in the hardware layer stores the flow identification information, the packet matching domain information, and the execution action information. In response to the first forwarding flow table containing the packet matching domain information and the execution action information matching the packet information, the hardware layer processes the packet information based on the execution action information. Otherwise, the hardware layer looks up the execution action information from the second forwarding flow table in the software layer based on the flow identification information and processes the packet information based on the execution action information.

It should be noted that the flow identification information and the packet matching domain information for the same packet information in the first forwarding flow table of the hardware layer and the second forwarding flow table of the fastpath module in the software layer are the same and can be issued by the slowpath module.

It should be understood that, in response to the first forwarding flow table in the hardware layer not containing the packet matching domain information matching the packet information, the packet information is sent to the slowpath module in the software layer for processing to generate the third forwarding flow entry. As described in the first embodiment of the data processing method, the packet information is first sent to the fastpath module in the software layer to look up the target packet matching domain information from the second forwarding flow table. In response to the second forwarding flow table containing the target packet matching domain information, the packet information is processed based on the target execution action information corresponding to the target packet matching domain information, thereby avoiding resource waste caused by directly sending the packet information to the slowpath module to regenerate the third forwarding flow entry due to lookup failures in the first forwarding flow table (e.g., due to update anomalies).

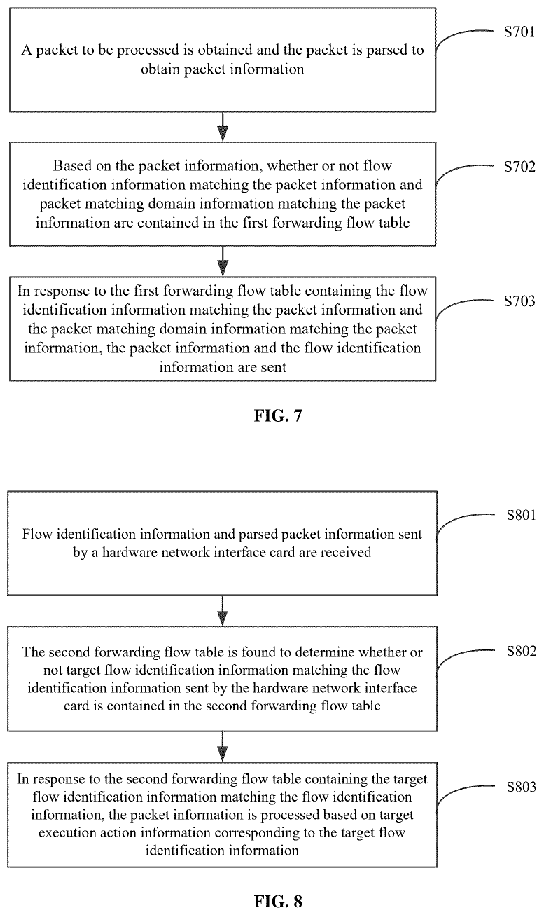

Based on the above, some embodiments of the present disclosure further provide a data processing method, as shown in FIG. 7. FIG. 7 is a flowchart of a data processing method according to a third embodiment of the present disclosure. The third embodiment is mainly described from the perspective of the hardware layer of the smart network interface card. In scenarios combining software and hardware to enhance CPU performance, the software layer and the hardware layer can be processed by different devices, such as hardware gateway devices, hardware load balancing devices, etc. Therefore, the hardware layer and the software layer are not limited to being set up on the smart network interface card but can also be set up on other hardware devices or on different hardware devices.

The third embodiment of this method is applied to a hardware network interface card. The hardware network interface card stores a first forwarding flow table. The first forwarding flow table includes the flow identification information and the packet matching domain information corresponding to the flow identification information, but the first forwarding flow table does not include the execution action information corresponding to the packet matching domain information. The method includes the following steps.

In step S701, a packet to be processed is obtained and the packet is parsed to obtain packet information.

In step S702, based on the packet information, whether or not flow identification information matching the packet information and packet matching domain information matching the packet information are contained in the first forwarding flow table.

In step S703, in response to the first forwarding flow table containing the flow identification information matching the packet information and the packet matching domain information matching the packet information, the packet information and the flow identification information are sent.

It should be understood that, in response to the first forwarding flow table not containing the flow identification information matching the packet information and the packet matching domain information matching the packet information, the packet information is sent.

Steps S701 to S703 can refer to the descriptions of the first embodiment and the second embodiment of the data processing method. The flow identification information and the packet information sent in step S703 are sent to the fastpath module in the software layer of the smart network interface card or sent to the fastpath module in the software layer of other hardware devices. Therefore, the data processing method of this embodiment is not limited to the smart network interface card.

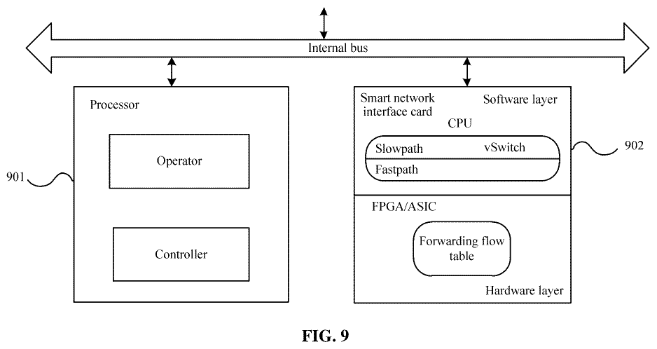

Based on the above, some embodiments of the present disclosure further provide a data processing method, as shown in FIG. 8. FIG. 8 is a flowchart of a data processing method according to a fourth embodiment of the present disclosure. The fourth embodiment is mainly described from the perspective of the software layer of a smart network interface card. In scenarios combining software and hardware to enhance CPU performance, the software layer and the hardware layer can be processed by different devices, such as hardware gateway devices, hardware load balancing devices, etc. Therefore, the hardware layer and the software layer are not limited to being set up on the smart network interface card but can also be set up on other hardware devices or on different hardware devices for data processing. This embodiment is described using the smart network interface card as an example. The fourth embodiment is applied to a software network interface card. The software network interface card stores a second forwarding flow table. The second forwarding flow table includes the flow identification information, the packet matching domain information corresponding to the flow identification information, and the execution action information corresponding to the packet matching domain information. The method includes the following steps.

In step S801, flow identification information and parsed packet information sent by a hardware network interface card are received.

In step S802, the second forwarding flow table is found to determine whether or not target flow identification information matching the flow identification information sent by the hardware network interface card is contained in the second forwarding flow table.

In step S803, in response to the second forwarding flow table containing the target flow identification information matching the flow identification information, the packet information is processed based on target execution action information corresponding to the target flow identification information.

The content of steps S801 to S803 can refer to the descriptions of the first embodiment and the second embodiment of the data processing method, which will not be detailed here. Similarly, in response to the result of step S802 being negative, the slowpath module in the software layer is required to process the packet information. The specific process is the same as in the first embodiment and the second embodiment, which includes the following steps.

In step S804-1, the slowpath module in the software layer processes the received packet information and generates the third forwarding flow entry for the packet information. The third forwarding flow entry includes: the packet matching domain information corresponding to the packet information, the flow identification information corresponding to the packet matching domain information, and the execution action information corresponding to the packet matching domain information.

In step S804-2: the third forwarding flow entry is sent to the fastpath module. To ensure that the information in the first forwarding flow table of the hardware layer is synchronized or consistent with the information in the second forwarding flow table of the software layer. The method further includes the following steps. In step S804-3, the flow identification information and the packet matching domain information in the third forwarding flow entry are sent to the hardware layer.

Based on the above content, some embodiments of the present disclosure further provide an electronic device, as shown in FIG. 9. FIG. 9 is a structural schematic diagram of an electronic device according to some embodiments of the present disclosure, including: a processor 901 and a smart network interface card 902. The smart network interface card is arranged for receiving execution tasks from the processor 901 and processing the execution tasks according to the relevant content of steps S301 to S304, or according to the relevant content of steps S601 to S606, or according to the relevant content of steps S701 to S703, or according to the relevant content of steps S801 to S803.

Based on the above, some embodiments of the present disclosure further provide a computer storage medium for storing data generated by a network platform and a program for processing the data generated by the network platform.

In response to being read and executed by the processor, the program performs the steps of the data processing method described in the embodiments mentioned above.

In a typical configuration, a computing device includes at least one processor (namely CPU), an input/output interface, a network interface, and a memory.

The memory includes non-persistent storage media, Random Access Memory (RAM), and/or non-volatile memory forms of a computer-readable medium, such as Read-Only Memory (ROM) or flash RAM. The memory is an example of the computer-readable medium.
1. The computer-readable medium includes both permanent and non-permanent, removable and non-removable media that can be implemented by any method or technology for storing information. Information can be computer-readable instructions, data structures, program modules, or other data. Examples of computer storage media include, but are not limited to, Parallel Random Access Machine (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory, or other memory technologies, Compact Disc Read-Only Memory (CD-ROM), Digital Versatile Discs (DVD), or other optical storage, magnetic cassettes, magnetic tape, magnetic disk storage, or other magnetic storage devices, or any other non-transmission media that can be used for storing information accessible by a computing device. According to this definition, the computer-readable medium do not include transitory media such as modulated data signals and carriers.
2. A person skilled in the art should understand that the embodiments of the present disclosure can be provided as methods, systems, or computer program products. Therefore, the present disclosure can adopt the form of complete hardware embodiments, complete software embodiments, or embodiments combining software and hardware. Moreover, the present disclosure can adopt the form of computer program products implemented on at least one computer-usable storage media (including but not limited to disk storage, CD-ROM, optical storage, etc.) containing computer-usable program code.

Although the present disclosure has been disclosed in the above embodiments, it is not intended to limit the present disclosure. A person skilled in the art can make possible changes and modifications without departing from the spirit and scope of the present disclosure. Therefore, the protection scope of the present disclosure should be determined by the claims of the present disclosure.

1. A smart network interface card, comprising: a hardware layer and a software layer;
the hardware layer comprises a packet parsing module, a first storage module, a first flow table lookup module, and a first transmission module; wherein
the packet parsing module is arranged for parsing a packet to obtain packet information;
the first storage module is arranged for storing a first forwarding flow table, the first forwarding flow table comprises flow identification information and packet matching domain information corresponding to the flow identification information, but does not comprise execution action information corresponding to the packet matching domain information;
the first flow table lookup module is arranged for looking up the packet matching domain information matching the packet information and the flow identification information corresponding to the packet matching domain information from the first forwarding flow table;
the first transmission module is arranged for sending the flow identification information found by the first flow table lookup module and the packet information to a fastpath module in the software layer; and
the software layer comprises the fastpath module;
the fastpath module comprises a second storage module, a second flow table lookup module and a processing module;
the second storage module is arranged for storing a second forwarding flow table, the second forwarding flow table comprises flow identification information, packet matching domain information corresponding to the flow identification information, and execution action information corresponding to the packet matching domain information;
the second flow table lookup module is arranged for looking up target flow identification information matching the flow identification information sent by the first transmission module from the second forwarding flow table; and
the processing module is arranged for processing the packet information based on the execution action information corresponding to the target flow identification information.

2. The smart network interface card according to claim 1, wherein the software layer further comprises a slowpath module;
the slowpath module comprises a generation module and a third transmission module;
the generation module is arranged for generating, in response to the first forwarding flow table not containing the packet matching domain information matching the packet information, and/or in response to the packet is an initial packet, a third forwarding flow entry according to the processing performed on at least one of the packet information and the initial packet, the third forwarding flow entry comprises the packet matching domain information corresponding to at least one of the packet information and the initial packet, the flow identification information corresponding to the packet matching domain information, and the execution action information corresponding to the packet matching domain information;
the third transmission module is arranged for sending the flow identification information and the packet matching domain information in the third forwarding flow entry to the first storage module of the hardware layer, and sending the third forwarding flow entry to the second storage module of the fastpath module.

3. The smart network interface card according to claim 1, wherein the hardware layer further comprises a data cache, the data cache comprises a plurality of data cache queues, arranged for caching the packet information that has completed the lookup in the first forwarding flow table in pre-set batches, and caching the packet information with the same flow identification information in the same data cache queue;
the first transmission module in the hardware layer is arranged for simultaneously sending the packet information and the flow identification information of the same group of packets stored in the same data cache queue to the fastpath module in the software layer; and
the processing module in the fastpath module is arranged for looking up target flow identification information from the second forwarding flow table and performing the same processing on the packet information in the same data cache queue based on target execution action information corresponding to the target flow identification information.

4. A data processing method, wherein the data processing method is applied to the smart network interface card, and the method comprises:
a hardware layer receiving a packet to be processed, parsing the packet to be processed to obtain packet information, and looking up whether or not packet matching domain information matching the packet information is contained in the first forwarding flow table;
in response to looking up the packet matching domain information matching the packet information from the first forwarding flow table, sending flow identification information corresponding to the packet matching domain information and the packet information to a software layer;
a fastpath module in the software layer looking up target flow identification information matching the flow identification information from a second forwarding flow table based on the flow identification information, determining target execution action information corresponding to the packet information based on the target flow identification information; and
the fastpath module processing the packet information based on the target execution action information.

5. The data processing method according to claim 4, further comprising:
in response to not looking up the packet matching domain information matching the packet information from the first forwarding flow table, and/or, in response to the packet to be processed being an initial packet, the hardware layer sending at least one of the packet information and the initial packet to a slowpath module in the software layer;
the slowpath module generating a third forwarding flow entry based on the processing performed on at least one of the packet information and the initial packet, the third forwarding flow entry comprises the packet matching domain information corresponding to at least one of the packet information and the initial packet, the flow identification information corresponding to the packet matching domain information, and execution action information corresponding to the packet matching domain information, sending the third forwarding flow entry to a second storage module of the fastpath module, and sending the flow identification information and the packet matching domain information in the third forwarding flow entry to a first storage module of the hardware layer;
the second storage module of the fastpath module updating the second forwarding flow table based on the third forwarding flow entry and processing the packet information based on the execution action information corresponding to the packet information recorded in the updated second forwarding flow table; and
the first storage module of the hardware layer updating the first forwarding flow table based on the flow identification information and the packet matching domain information in the third forwarding flow entry.

6. The data processing method according to claim 5, further comprising:
the hardware layer dividing the packet information that has completed the lookup in the first forwarding flow table in pre-set batches into the same group of packets according to the same flow identification information, and caching the packet information of the same group of packets in a data cache queue of the hardware layer, wherein the packet information with the same flow identification information is cached in the same data cache queue;
simultaneously sending the flow identification information and the packet information of the same group of packets to the fastpath module; and
the fastpath module looking up the target flow identification information matching the flow identification information from the second forwarding flow table based on the flow identification information, and processing the packet information of the same group of packets based on the target execution action information, determined according to the target flow identification information, corresponding to the packet information of the same group of packets.

7. The data processing method according to claim 6, wherein sending the flow identification information and the packet information of the same group of packets to the fastpath module comprises:
sending the flow identification information of the same group of packets to the fastpath module in vector form, wherein a vector comprises the same flow identification information of the same group of packets; and
the fastpath module looking up the target flow identification information matching the flow identification information from the second forwarding flow table based on the flow identification information, and processing the packet information of the same group of packets based on the target execution action information, determined according to the target flow identification information, corresponding to the packet information of the same group of packets comprises:
the fastpath module looking up the target flow identification information matching the same flow identification information from the second forwarding flow table based on the same flow identification information, and processing the packet information of the same group of packets based on the target execution action information corresponding to the target flow identification information.

8. A smart network interface card, comprising: a hardware layer and a software layer;
the hardware layer comprises a packet parsing module, a first storage module, a first flow table lookup module, a first transmission module, and a first processing module; wherein
the packet parsing module is arranged for parsing a packet to obtain packet information;
the first storage module is arranged for storing a first forwarding flow table, the first forwarding flow table comprises flow identification information, packet matching domain information corresponding to the flow identification information, and execution action information corresponding to the packet matching domain information;
the first flow table lookup module is arranged for looking up the packet matching domain information matching the packet information, and the flow identification information corresponding to the packet matching domain information from the first forwarding flow table;
the first processing module is arranged for processing the packet information based on the execution action information in response to the first forwarding flow table containing the execution action information corresponding to the flow identification information;
the first transmission module is arranged for sending the flow identification information and the packet information to a fastpath module in the software layer in response to the first forwarding flow table not containing the execution action information corresponding to the flow identification information; and
the software layer comprises the fastpath module, the fastpath module comprises a second storage module, a second flow table lookup module, and a second processing module;
the second storage module is arranged for storing a second forwarding flow table, the second forwarding flow table comprises the flow identification information, the packet matching domain information corresponding to the flow identification information, and the execution action information corresponding to the packet matching domain information;
the second flow table lookup module is arranged for looking up the target flow identification information matching the flow identification information sent by the first transmission module from the second forwarding flow table; and
the second processing module is arranged for processing the packet information based on the target execution action information corresponding to the target flow identification information.

9. The smart network interface card according to claim 8, wherein the first transmission module is further arranged for sending the packet information to a slowpath module in the software layer in response to the first forwarding flow table not containing the packet matching domain information corresponding to the packet information;
the slowpath module in the software layer comprises a generation module and a third transmission module,
the generation module is arranged for generating a third forwarding flow entry based on the processing performed on the packet information in response to the first forwarding flow table not containing the packet matching domain information matching the packet information, and/or in response to the packet being an initial packet, the third forwarding flow entry comprises the packet matching domain information corresponding to at least one of the packet information and the initial packet, the flow identification information corresponding to the packet matching domain information, and the execution action information corresponding to the packet matching domain information;
the third transmission module is arranged for sending the third forwarding flow entry to the second storage module, in response to the hardware layer not supporting the processing of the execution action information, sending the flow identification information and the packet matching domain information in the third forwarding flow entry to the first storage module, and in response to the hardware layer supporting the processing of the execution action information, sending the third forwarding flow entry to the first storage module.

10. The smart network interface card according to claim 8, wherein the hardware layer further comprises a data cache, the data cache comprises a plurality of data cache queues, arranged for caching the packet information that has completed the lookup in the first forwarding flow table in pre-set batches, and caching the packet information with the same flow identification information in the same data cache queue;
the first transmission module in the hardware layer is arranged for simultaneously sending the packet information and the flow identification information of the same group of packets stored in the same data cache queue to the fastpath module in the software layer; and
the processing module in the fastpath module is arranged for looking up target flow identification information from the second forwarding flow table and performing the same processing on the packet information in the same data cache queue based on target execution action information corresponding to the target flow identification information.

11-16. (canceled)

17. The smart network interface card according to claim 1, wherein the hardware layer is a Field Programmable Gate Array or an Application Specific Integrated Circuit.

18. The smart network interface card according to claim 1, wherein the packet matching domain information is used for recording the packet information after parsing the packet.

19. The smart network interface card according to claim 18, wherein the packet information is five-tuple of the packet, wherein the five-tuple comprises: a source internet protocol address, a destination internet protocol address, a source port, a destination port and a protocol.

20. The smart network interface card according to claim 1, wherein the software layer is a virtual switch or an operating system.

21. The smart network interface card according to claim 1, wherein the execution action information is used for recording information obtained by processing the packet information, wherein the execution action information comprises at least one of the following: encapsulation, de-encapsulation, forwarding, rate limiting.

22. The smart network interface card according to claim 1, wherein the first forwarding flow table and the second forwarding flow table store the same flow identification information and the packet matching domain information for the same packet.

23. The smart network interface card according to claim 1, wherein the packet information and flow identification information of the same group of packets are sent to the fastpath module in vector form.

24. The smart network interface card according to claim 23, wherein identification information of a vector corresponds to the same flow identification information.

25. The smart network interface card according to claim 24, wherein the fastpath module looks up the target flow identification information matching the identification information of the vector from the second forwarding flow table, and processes the packet information of the same group of packets according to the target execution action information corresponding to the target flow identification information.

26. The data processing method according to claim 4, wherein the hardware layer receiving the packet to be processed, parsing the packet to be processed to obtain the packet information, and looking up whether or not the packet matching domain information matching the packet information is contained in the first forwarding flow table comprising:
parsing the obtained packet to obtain the packet information, the packet information comprising tuple information;
comparing the tuple information in the packet information with the tuple information in the packet matching domain information to determine whether or not the tuple information in the packet information is matched with the tuple information in the packet matching domain information;
in response to the tuple information in the packet information being matched with the tuple information in the packet matching domain information, it is determined that the packet matching domain information matching the packet information is contained in the first forwarding flow table in the hardware layer.
